(19) United States
(12) Patent Application Publication
(10) Pub. No.: US 2015/0308187 A1
(43) Pub. Date: Oct. 29, 2015

(54) WIND-RESISTANT SUN-PROOF BLIND

(71) Applicant: NINGBO XIANFENG NEW MATERIAL CO., LTD, Ningbo , Zhejiang (CN)

(72) Inventors: Xianfeng Lu, Ningbo City, Zhejiang Province (CN); Shiju Yang, Ningbo City, Zhejiang Province (CN)

(21) Appl. No.: 14/649,520

(22) PCT Filed: Dec. 18, 2013
(86) PCT No.: PCT/CN2013/089867

§ 371 Date: Jun. 3, 2015

(30) Foreign Application Priority Data
May 3, 2013 (CN) 201310160497.9

(51) Int. Cl. E06B 9/42

(52) U.S. Cl. CPC E06B 9/42

(57) ABSTRACT

The present invention provides a wind-resistant sun-proof blind in the field of mechanical technology, which addresses poor wind resistance of the conventional blinds. The wind-resistant Sun-proof blind of the invention comprises a curtain cloth, a window cover and a reel pipe assembly ratably mounted within the window cover, in which the curtain cloth is wound outside of the reel pipe assembly, each of both ends of the window cover has a downward lateral rail fixedly connected therewith, and the side of the lateral rail facing to the curtain cloth has a longitudinal opening. Two symmetrically disposed lock bars are mounted within the lateral rail along the longitudinal direction, a gap is formed between the said two lock bars, and the upper opening of the gap is in communication with the window cover. Two lateral edges of the curtain cloth extend into the inner cavity of the lateral rail and are transversely fixedly connected with a flexible positioning element after passing through the longitudinal opening of the lateral rail on the same side and the gap between the said two lock bars respectively. The reel pipe assembly has two symmetrically disposed annular grooves and when the curtain cloth is wound around the reel pipe, both lateral edges of the curtain cloth are wound at the corresponding annular grooves respectively, and the outer diameter of the positioning element is larger than the width of the gap between the two lock bars. The present invention has advantages by providing a firm and reliable structure, a good guide nature and strong wind resistance.

### BACKGROUND OF THE INVENTION

1. Field of Invention

The present invention relates to a blind, particularly to a wind-resistant sun-proof blind in the field of mechanical technology.

2. Related Art

People are used to pulling the blind down to shield off sunshine in hot summers. However, the wind blown into the room through windows will swing the blind back and forth. In such a case, not only a poor sun-proof effect of the blind is produced, but also noises will be generated by the blind that wings back and forth. Particularly rest and study of students as well as relaxation of patients will be adversely impacted as such in locations like schools and hospitals.

To this end, someone invented a wind-resistant sun-proof blind. At present the outdoor wind-resistant sun-proof blind employs a wire rope to prevent moving, but the wire rope could only fix the lower end of curtain cloth. When the wind power is strong, the blind tends to be blown up as a hole, producing a poor wind-resistant effect. Another wind-resistant blind, such as that is disclosed in Chinese patent CN201519032U, is connected with several post-like weights at equal distances at its bottom. A hook is provided at the bottom of the weight, and a protective cover is located on the threads on the surface of the post-like weights. Even though this blind could address problems with ordinary blinds, like poor stability and easy blow-up by wind, the structure of the blind is complicated and the wind-resistant effect can only be achieved if the blind is completely laid down, which cannot exhibit multiple functions. Nylon zippers are provided on both sides of the curtain cloth in some blinds. In such blinds with nylon zippers, the thickness of the curtain cloth is different from that of nylon zippers, and there is displacement when the curtain cloth is wound. A power-saving wind-resistant blind dedicated to classrooms, is disclosed in Chinese Patent CN200964780Y, Both ends of the blind are disposed in two symmetric upper holders. An upper ratchet wheel is provided at one end of the upper roller for driving the upper roller to rotate. An annular ratchet wheel zipper is covered on the upper ratchet wheel. An annular connection bar covered on both ends of the upper and lower rollers is located, between the upper roller and lower roller. The connection bar is tightened between the upper roller and the lower roller. A central roller is positioned between two central holders for winding the sun-proof spoke. The lower end of the sun-proof spoke is fixed on the annular connection bars on both sides via a crossbar. Even though the blind is effectively wind-resistant, it has a complicated structure, is difficult to operate, has to be operated purely manpower, and cannot be easily mounted.

### SUMMARY OF THE INVENTION

In order to address the aforesaid defects, the present invention provides a wind-resistant sun-proof blind which has a firm and reliable structure, a good guide nature and strong wind resistance.

It is therefore an object of the present invention to provide a wind-resistant sun-proof blind, comprising a curtain cloth, a window cover and a reel pipe assembly rotably mounted within the window cover, in which the curtain cloth is wound outside of the reel pipe assembly, the reel pipe assembly turns to drive the curtain cloth to roll out or in, each of both ends of the window cover has a downward lateral rail fixedly connected therewith, and the side of the lateral rail facing to the curtain cloth has a longitudinal opening. Two symmetrically disposed lock bars are mounted within the lateral rail along the longitudinal direction, and a gap facing to one side of the curtain cloth is formed between the said two lock bars, and the upper opening of the gap is in communication with the window cover. Two lateral edges of the curtain cloth extend into the inner cavity of the lateral rail and are transversely fixedly connected with a flexible positioning element after passing through the longitudinal opening of the lateral rail on the same side and the gap between the said two lock bars respectively. The reel pipe assembly has two symmetrically disposed annular grooves and when the curtain cloth is wound around the reel pipe, both lateral edges of the curtain cloth are wound at the corresponding annular grooves respectively, and the outer diameter of the positioning element is larger than the width of the gap between the two lock bars.

In the wind-resistant sun-proof blind of the invention, the reel pipe assembly includes a reel pipe and an active wheel plug and a passive wheel plug inserted and fixed into both ends of the reel pipe, the annular grooves are opened on the portions of the active wheel plug and passive wheel plug exposed out of the reel pipe respectively, and the outer diameter of the annular grooves is smaller than the diameter of the reel pipe and the width of the curtain cloth is larger than the length of the reel pipe.

In the wind-resistant sun-proof blind of the invention, the length of the positioning element is identical to that of the curtain cloth and the positioning element is fixedly connected with the lateral edge of the curtain cloth by sewing.

In the wind-resistant sun-proof blind of the invention, each of both lateral edges of the curtain cloth is fixedly connected with a skirt, and the curtain cloth is transversely fixedly connected with the positioning element through the skirts.

In the wind-resistant sun-proof blind of the invention, the lower edge of the curtain cloth is connected with a transversely disposed lower rod, the lower end of the lateral rail is fixedly connected with a bulkhead, a steel wire wheel having a scroll spring is mounted on the bulkhead, a traction steel wire is wound around the steel wire wheel and has one end wound and fixed onto the steel wire wheel and the other end fixedly connected with the lower rod.

In the wind-resistant sun-proof blind of the invention, a rocker gear case having a hang ring is connected with the outer end of the active wheel plug and a vertically disposed rocker is hung onto the hang ring.

In the wind-resistant sun-proof blind of the invention, the positioning element is a bead chain, a soft traction steel wire or a nylon rope.

In the wind-resistant sun-proof blind of the invention, two said window covers are provided including a first window cover and a second window cover; two said curtain cloths are provided including a first telescopic curtain cloth and a second telescopic curtain cloth; the first window cover is mounted at the upper portion of the first window frame, the first window frame has a first window and the first telescopic curtain cloth is provided within the first window cover;

the second window frame is fixedly connected with one side of the first window frame and has a second window, the second window is corresponding to the position of the first window, the second window cover is mounted at the upper portion of the second window frame, and the second telescopic curtain cloth is provided within the second window cover; or, a lateral seal is fixedly connected with one side of the first window frame and has a second window, and the second window is corresponding to the position of the first window.

In the wind-resistant sun-proof blind of the invention, symmetrical support parts and guide parts are disposed on both sides of the first window frame, the support part and the guide part on the same side are integrated, with each other, the upper end of the support part is higher than that of the guide part, that is to say, a gap is formed above the support part and guide part on the same side; and the first window cover is mounted at the gaps on both sides of the first window frame.

In the wind-resistant sun-proof blind of the invention, an upper slide is connected with the upper end of the support parts on both sides, a lower slide is connected with the lower end of the support parts on both sides, and the upper slide is corresponding to the lower slide.

In the wind-resistant sun-proof blind of the invention, the lateral seal is formed by vertical seals on both sides, the upper slide connected with the upper end of the seals on both sides and the lower slide connected with the lower end of the seals on both sides, in which the upper slide is corresponding to the lower slide.

In the wind-resistant sun-proof blind of the invention, a first slot is opened on one side of the support part along the longitudinal direction, and a second slot is opened on one side of the lateral seal along the longitudinal direction correspondingly; and two lateral edges of a plastic strip are inserted and fixed into the first slot and the second slot on the same side respectively.

In the wind-resistant sun-proof blind of the invention, a lateral seal limiting part is provided on the inner side of the seal on one side for positioning the sliding window, and a window body limiting, part is provided on the inner side of the first window frame support part on the opposite side.

In the wind-resistant sun-proof blind of the invention, symmetric support parts and guide parts are disposed on both sides of the second window frame, the support part and the guide part on the same side are integrated with each other, the upper end. of the support part is higher than that of the guide part, that is to say, a gap is formed above the support part and guide part on the same side; and the second window cover is mounted at the gaps on both sides of the second window frame.

In the wind-resistant sun-proof blind of the invention, the bead chain is made from several plastic beads fixedly connected to one nylon rope and spaced from each other, the distance between adjacent beads is 12-20 mm, and the diameter of the heads is 2.5-4 mm.

In the wind-resistant sun-proof blind of the invention, the length of the annular grooves is 15-40 mm and the depth thereof is 2-6 mm.

The wind-resistant sun-proof blind of the invention has the following advantages over the prior art:

Firstly, a flexible positioning element is fixedly connected with both lateral edges of the curtain cloth by sewing. The positioning element moves along with the curtain cloth, to makes sure the positioning element will not be fixed to press against the skirts of the curtain cloth when the curtain cloth moves up and down under extremely strong wind, and the curtain cloth will not move up and down unsmoothly.

Meanwhile, the positioning element is fixedly connected with the skirts b sewing in such a manner that the positioning element could move up and down as the curtain cloth moves up and down. in other words, the positioning element moves along with the curtain cloth. As such, the positioning element will not be broken by too strong wind and the curtain cloth will not be damaged by the facture of the broken positioning element as the positioning element fixedly mounted within the lateral rails does not move synchronously with the curtain cloth.

Secondly, a steel wire wheel having a scroll spring is mounted on the bulkhead. A traction steel wire is wound around the steel wire wheel and has one end wound onto the steel wire wheel and the other end passing through the roller and fixedly connected with the lower rod. When the curtain cloth moves up, the traction steel wire tightens the scroll spring, and when the curtain cloth moves down, the curtain cloth is driven by elastic force of the scroll spring to move down. Consequently, the curtain cloth could smoothly move down even under wind pressures.

### BRIEF DESCRIPTION OF THE DRAWINGS

FIG. 1 is a diagram of the structure of the first embodiment;

FIG. 2 is an exploded diagram of the structure of the first embodiment;

FIG. 3 is a vertical section view of the first embodiment;

FIG. 4 is an enlarged diagram of the part A of FIG. 3;

FIG. 5 is transverse partial section view of the first embodiment;

FIG. 6 is a diagram of the structure of the second embodiment;

FIG. 7 is an exploded diagram of the structure of the second embodiment;

FIG. 8 is an exploded diagram of the structure of the front window cover of the second embodiment;

FIG. 9 is a stereogram of the structure of the sun-proof component of the second embodiment;

FIG. 10 is a longitudinal section view of the part a of FIG. 9;

FIG. 11 is a diagram of the structure of the bead chain;

FIG. 12 is an exploded view of the sun-proof component of the second embodiment:

FIG. 13 is a partial longitudinal section view of the sun-proof component of the second embodiment;

FIG. 14 is an exploded diagram of the structure of the window frame of the second embodiment;

FIG. 15 is an exploded diagram of the structure of the back window cover of the second embodiment;

FIG. 16 is a front view of the second embodiment;

FIG. 17 is an A-A section view of FIG. 16;

FIG. 18 is enlarged diagram of the structure of the part B of FIG. 17;

FIG. 19 is an exploded view of the structure of the indoor and outdoor window frame having a sliding window;

FIG. 20 is an exploded view of the part M of FIG. 19 (outdoor window frame, i.e., front window frame); and

FIG. 21 is an exploded view of the part N of FIG. 19 (indoor window frame, i.e., back window frame).

### DETAILED DESCRIPTION OF THE INVENTION

Embodiments of the present invention will be described in detail below with reference to the drawings. However, the present invention shall not be limited to these embodiments.

### First Embodiment

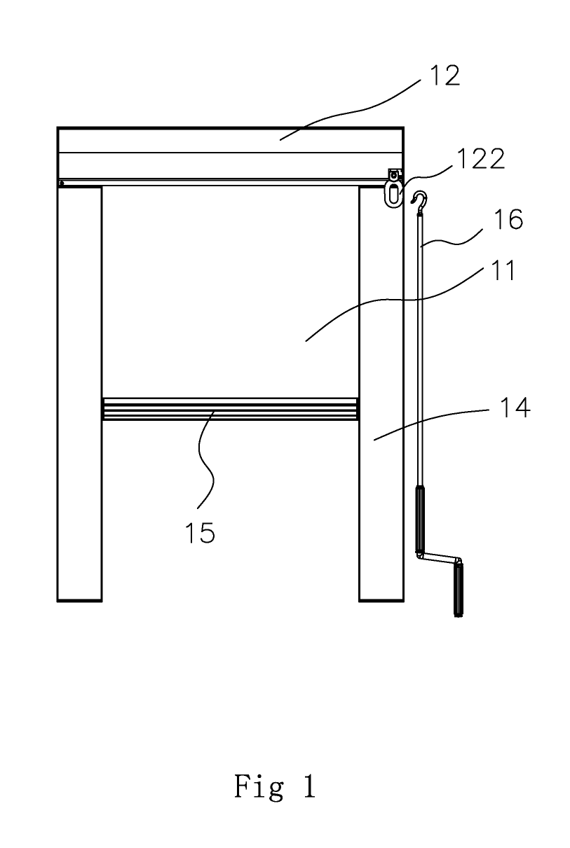

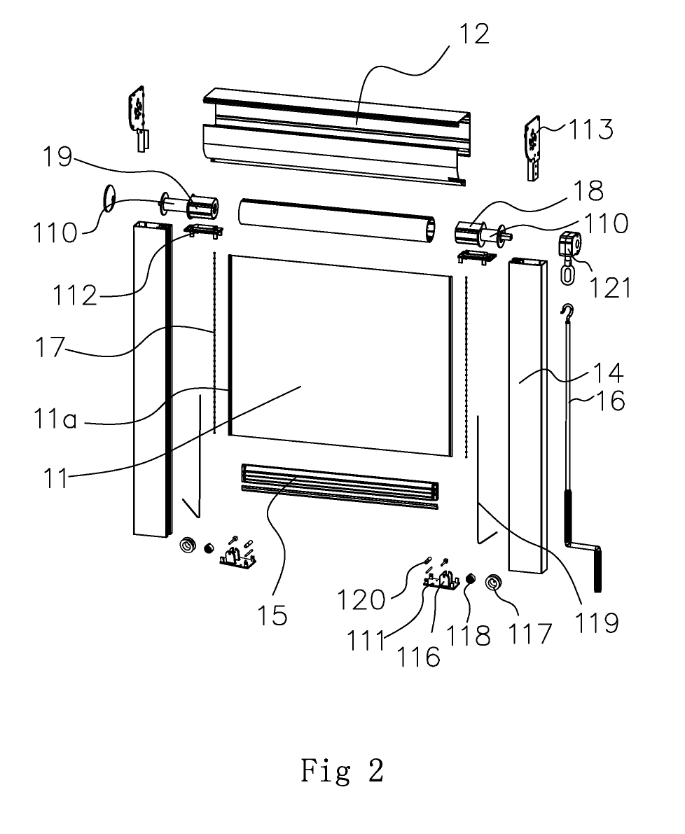

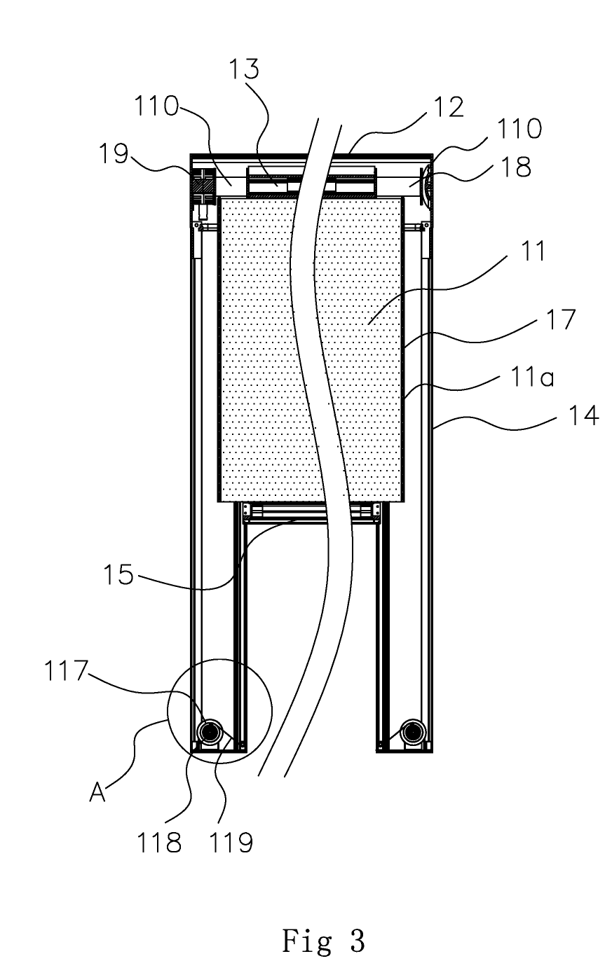

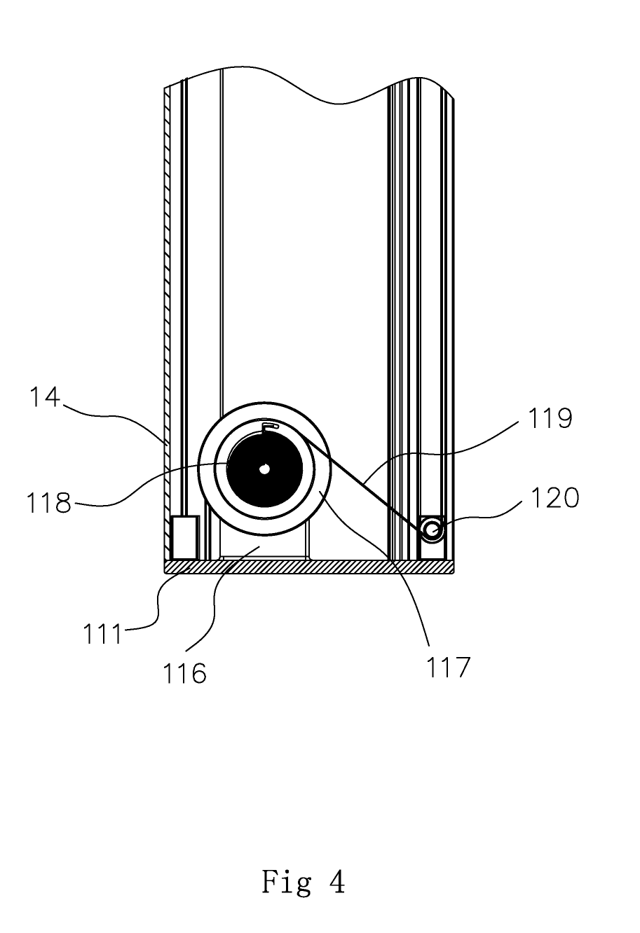

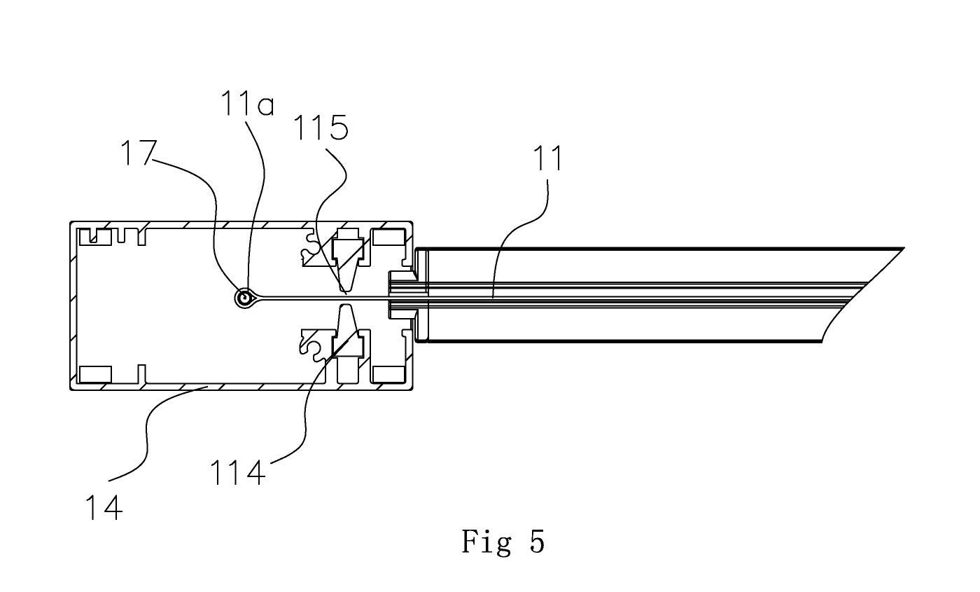

As shown in FIGS. 1-5 the wind-resistant sun-proof blind according to this embodiment comprises curtain cloth 11, a window cover 12, a reel pipe assembly mounted within the window cover 12, lateral rails 14 positioned on both sides of the curtain cloth 11, a lower rod 15 disposed at the lower end of the curtain cloth 11, a rocker 16 and so on. The reel pipe assembly is ratably mounted within the window cover 12. The curtain cloth 11 is wound outside of the reel pipe assembly. The rotation of the reel pipe assembly drives the curtain cloth 11 to unwind and wind. An end cap 113 is provided at each end of the window cover and is inserted and fixed into the upper end of the lateral rail 14.

Each end of the window cover 12 is fixedly connected to the aforesaid lateral rail 14. The lateral rails 14 have a longitudinal opening on their sides facing toward the curtain cloth 11. The lower end of the lateral rail 14 is fixedly connected with a bulkhead 111. The upper end of the lateral rail 14 is fixedly connected with a guide blank cap 112. The blank cap 112 could be used to pass through the edge of the curtain cloth 11 longitudinally. The impurities like dust, could not enter the lateral rails thanks to the bulkheads 111 and guide blank caps 112, which further guarantees tidiness of rails within the lateral mils 14 and alleviates difficulty for the curtain cloth 11 to move up and down because of jam of rails brought by too many impurities.

Two symmetrically disposed lock bars 114 are mounted into the lateral rail 14 along the longitudinal direction. A gap 115 is formed between two lock bars 114 to face to one side of the curtain cloth 11. The upper end of the gap 115 is in communication with the window cover 12. Two lateral edges of the curtain cloth 11 pass through the longitudinal opening of the lateral rail 14 on the same side and the gap 115 between the said two lock bars 114 respectively, and then extend into the inner cavity of the lateral rails 14 and are fixedly connected with flexible positioning elements 17 in a transverse direction. The positioning elements 17 move in an axial direction within the lateral rails 14 as the curtain cloth 11 moves up and down. The outer diameter of the positioning element 17 is larger than the width of gap between two lock bars 114, which ensures the positioning elements 17 will not be disengaged from the lateral rails 14.

A skirt 11a is fixed to each lateral edge of the curtain cloth 11a. The curtain cloth 11 passes through the skirts 11a and is fixedly connected with the positioning elements by transverse sewing. In this embodiment, the positioning element 17 is a bead chain, and could also be a soft traction steel wire 119 or a nylon rope or other circular soft belt upon actual circumstances and demands of the users. The length of the positioning elements 17 is identical to that of the curtain cloth 11, so that the curtain cloth 11 is held by the positioning elements through the skirts 11a and is always straightened when wind blows to the curtain cloth 11. This said, the curtain cloth 11 will not be easily swelled up. The positioning elements 17 will move outward along with the curtain cloth 11 even when the curtain cloth 11 is slighted swelled up when wind is extremely strong, ensuring that the positioning elements 17 will not he fixed against the skirts 11 a of the curtain cloth 11 and the curtain cloth 11 will not move up and down unsmoothly when the curtain cloth 11 moves up and down with extremely strong wind. Meanwhile, the positioning elements 17 are fixed to the skirts 11a by sewing, so that the positioning elements 17 will move up and down as the curtain cloth 11 moves up and down. In other words, the positioning elements 17 will move along with the curtain cloth 11. Accordingly, such an accident will not happen, in which the positioning elements 17 are fixedly mounted within the lateral rails 14. do not move in synchronization with the curtain cloth 11 and are broken by extremely strong wind, and the curtain cloth 11 is destroyed by the fracture of the broken positioning elements 17.

The skirts 11a could be made from cloth of ordinary nylon composite materials or ordinary chemical fiber materials, have good tensile resistance and are not easy to he broken. The skirt 11a could be folded to form a circumferentially closed space. As such, the positioning elements 17 could be inserted into the pace and fixedly connected with the skirts 11a by sewing.

The curtain cloth 11 and skirts I la could be fixed to each other by hot sealing under temperature of 150-400° C. by using a hot sealing machine or by sewing by using a sewing machine. Consequently, the curtain cloth 11 could be connected with the skirts 11a in a firmer manner. When wind is strong, the positioning elements 17 will hold the skirts 11a and the skins 11a and curtain cloth Ii will not be readily torn apart by wind, thus having good wind-resistance.

The reel pipe assembly includes a reel pipe 13 and an active wheel plug 18 and a passive wheel plug 19 inserted and fixed into both ends of the reel pipe 13. The width of the curtain cloth 11 is larger than length of the reel pipe. An annular groove 110 is provided on each of the portions of the active wheel plug 18 and passive wheel plug 19 out of the reel pipe 13, and has an outer diameter small than the diameter of the reel pipe 13. When the curtain cloth 11 is wound onto the reel pipe 13, both lateral edges of the curtain cloth 11 are respectively wound at the corresponding annular grooves 110. In other words, when the curtain cloth 11 moves up and is wound by the reel pipe 13, the positioning elements 17 are wound up and located at the corresponding annular grooves 110 as the curtain cloth 11 moves up. As the positioning elements 17 are fixedly connected with the skirts 11a by sewing, the thickness generated by winding up the skirts 11a, i.e., the superimposed thickness formed by winding up the positioning elements 17, is larger than the thickness formed by winding the curtain cloth 11 onto the reel pipe 13. Therefore, the winding and superimposition position of the positioning elements 17 is set at the annular grooves 110. In particular, when the skirts 11a are wound to the annular grooves 110, the skirts 11a tend to drop under gravity of the positioning elements 17. As there is a difference in heights of the annular grooves and the outer wall of the reel pipe, the difference compensates the difference between the thickness formed by winding the positioning elements 17 and the thickness formed when the curtain cloth 11 is wound onto the reel pipe 13. Therefore, the thickness of the skirts 11a is the same as that of the curtain cloth 11 and both the skirts 11a and curtain cloth 11a are always kept flat. In such a way to reduce the diameter of pipe at the winding position of the skirts 11a, when the curtain cloth 11 is wound by the reel pipe 13, the skirts 11a and curtain cloth 11 are always kept flat. As such, the curtain cloth 11 is orderly and flatly wound onto the reel pipe 13 as a whole, and is always kept flat when the curtain cloth 11 is wound by the reel pipe 13 or unwound from the reel pipe. The displacement problem existing in conventional wind-resistant blinds is addressed as such.

A transversely disposed lower rod 15 is connected with the lower edge of the curtain cloth 11. A wire wheel holder 116 and a roller 120 are provided vertically upwards from the bulkhead 111. A steel wire wheel 117 having a scroll spring 118 is mounted on the wire wheel holder 116. A traction steel wire 119 is wound around the steel wire wheel 117 and has one end wound onto the steel wire wheel 117 and the other end passing through the roller 120 and fixedly connected with the lower rod 15. An annular groove is opened on the roller 120, and the traction steel wire 119 passes through the annular groove which has a guiding and positioning effect, so that the traction steel wire 119 will not run away when passing through the roller 120. When the curtain cloth 11 moves up and is wound by the reel pipe 13, the steel wire wheel 117 turns to release the traction steel wire 119 and the traction steel wire 119 tightens the scroll spring 118; and when the curtain cloth 11 moves down, an upward force is exerted onto the curtain cloth 11 by wind as affected by wind pressure, i.e., an upward force is exerted onto the lower rod 15. The lower rod 15 tightens the traction steel wire 119 and tends to move up. The steel wire wheel 117 is to furl the traction steel wire 119 and thus both ends of the traction steel wire 119 are tightly held. As the scroll spring 118 is in a tensioning state previously, the scroll spring 118 releases its elastic force and drives the curtain cloth 11 to move down (that is to say, to exert a downward force onto the lower rod 15) when the curtain cloth 11 moves down. The elastic force released by the scroll spring 118 could offset and eliminate the force exerted by wind against the lower rod 5. As such, the curtain cloth 11 could smoothly move down even subject to wind pressure. Meanwhile, one end of the traction steel wire 119 is fixed on the steel wire wheel 117 and the other end thereof passes and winds through the roller 120 to be fixed to the lower rod 15 directly, shortening the winding path of the traction steel wire 19. In this case, the curtain cloth 11 could move up and down smoothly under action of the steel wire wheel 17 and have a better traction effect.

A rocker gear case 121 having a hang ring 122 is connected with the outer end of the active wheel plug. A vertically disposed rocker 16 is hung onto the bang ring. The reel pipe 13 is driven to rotate by turning the rocker 16, and the curtain cloth 11 is manually controlled to move up and down and could he operated simply and conveniently.

### Second Embodiment

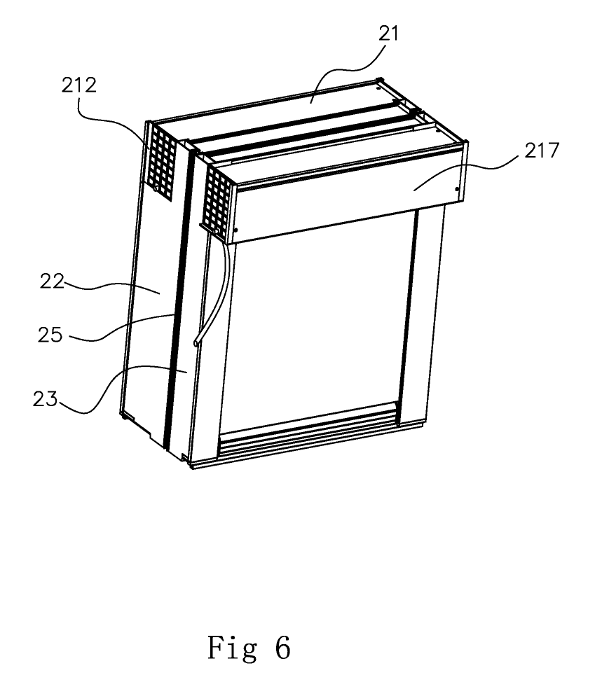

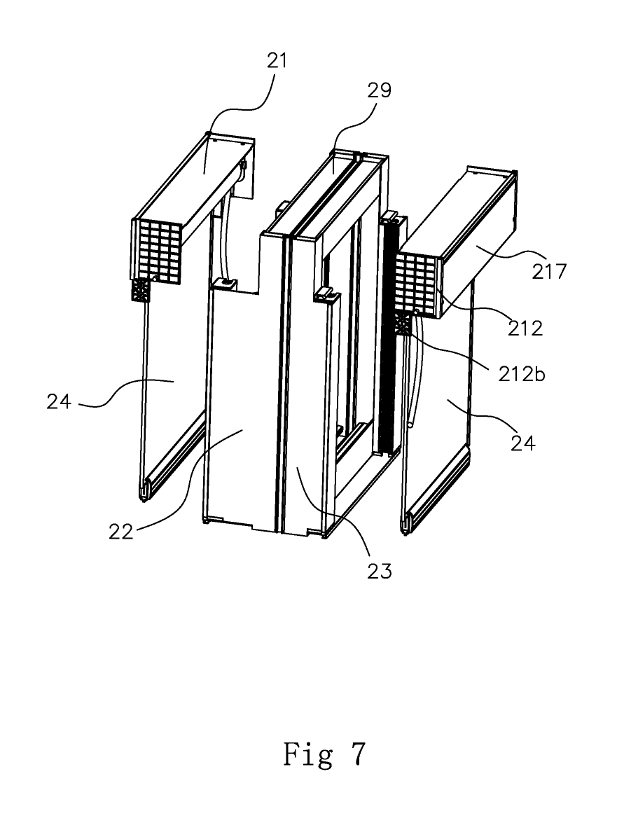

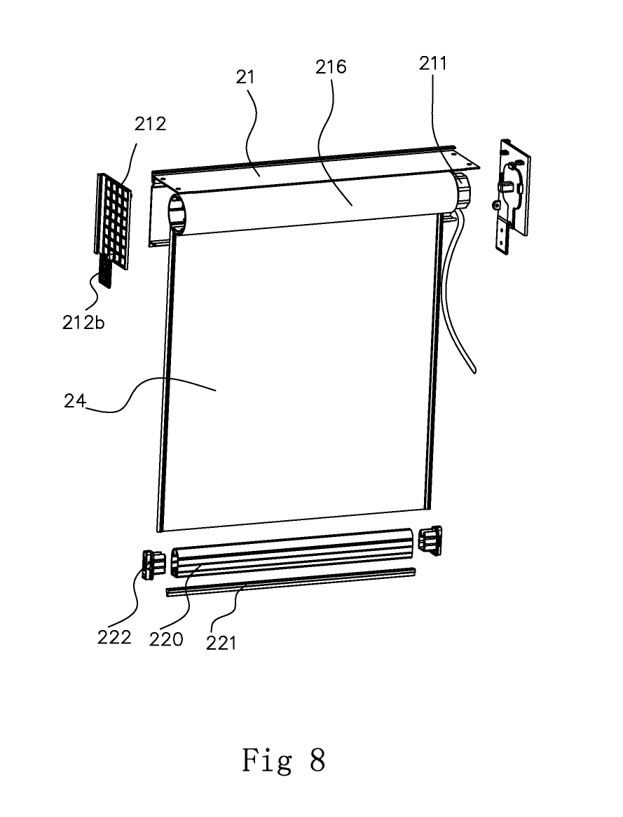

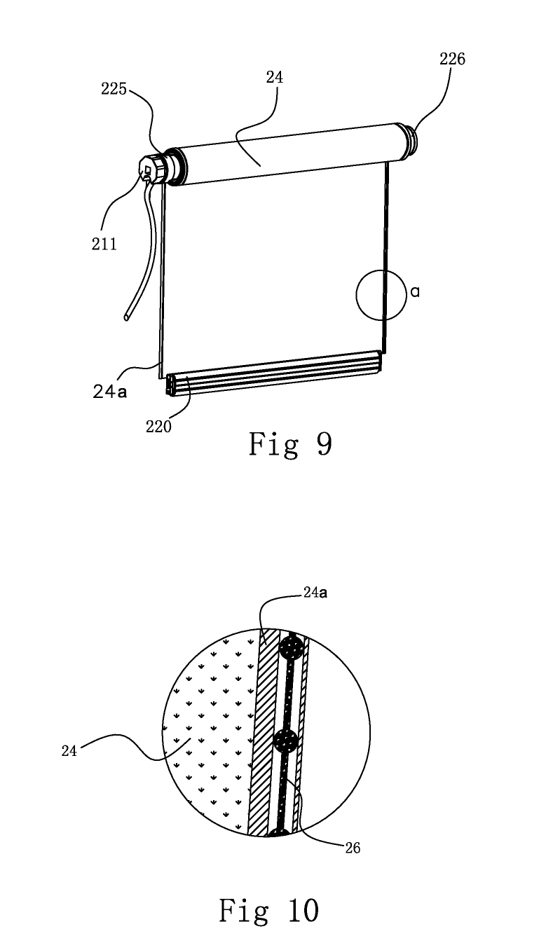

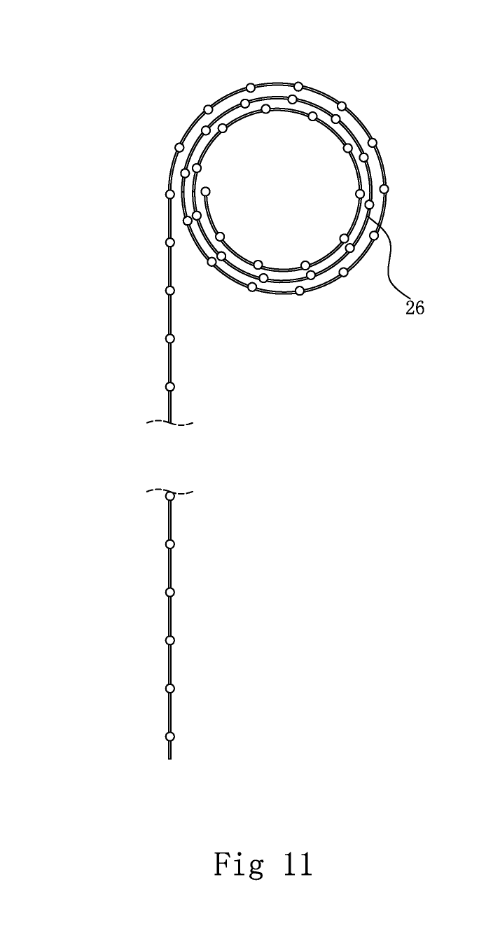

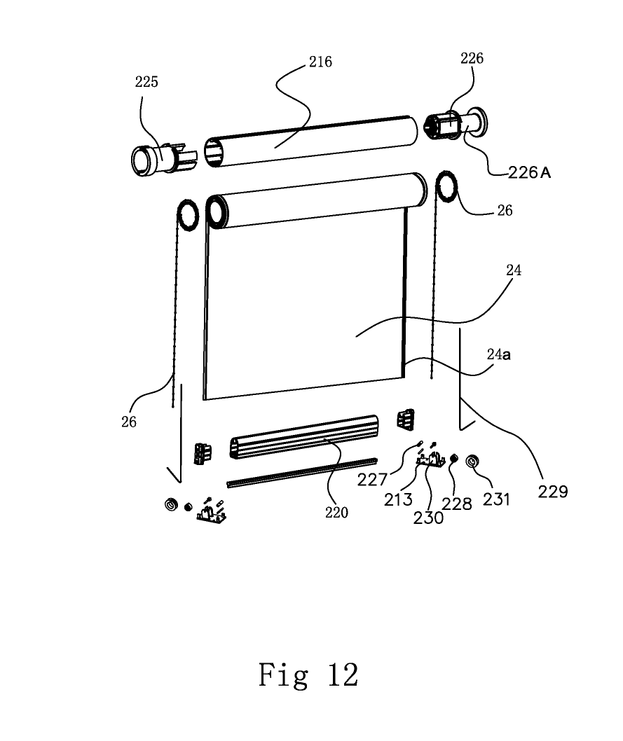

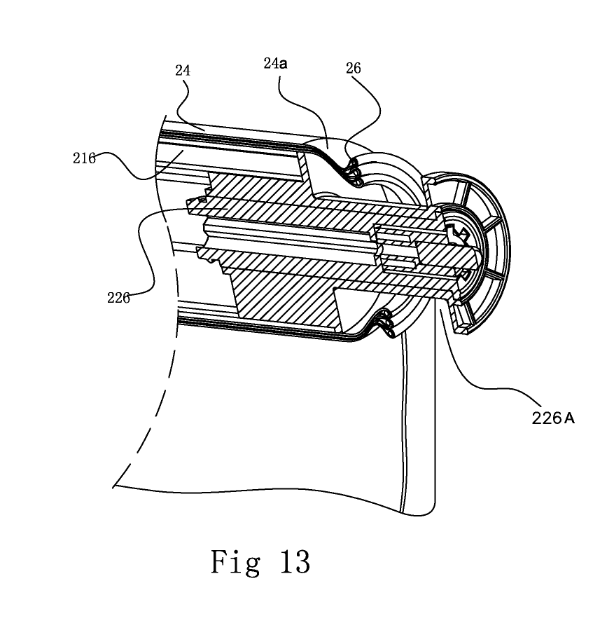

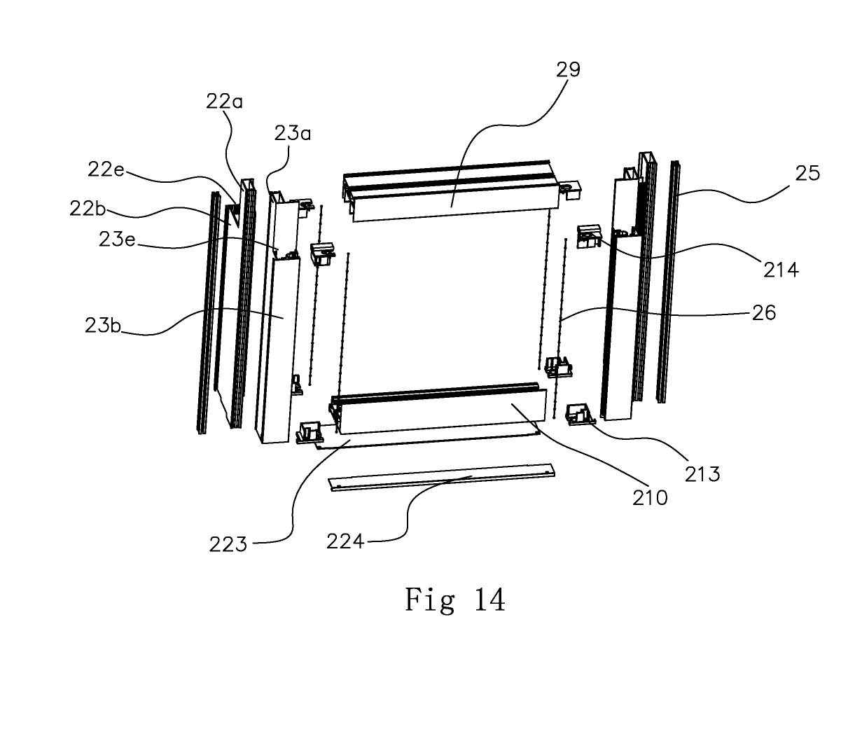

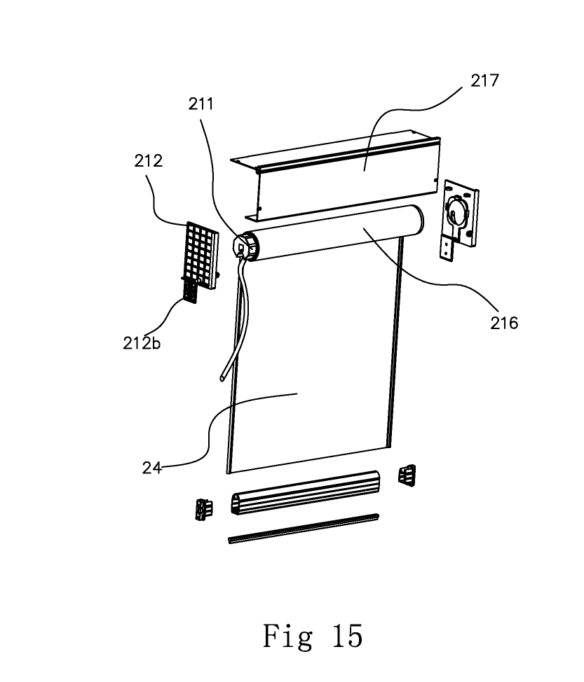

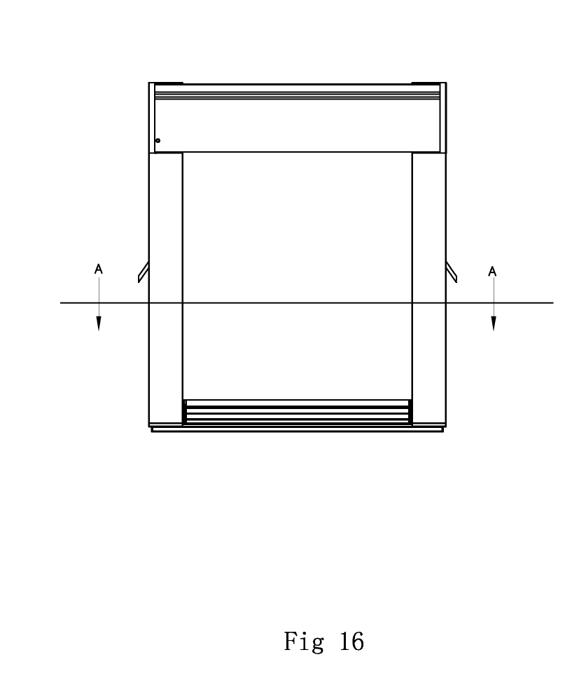

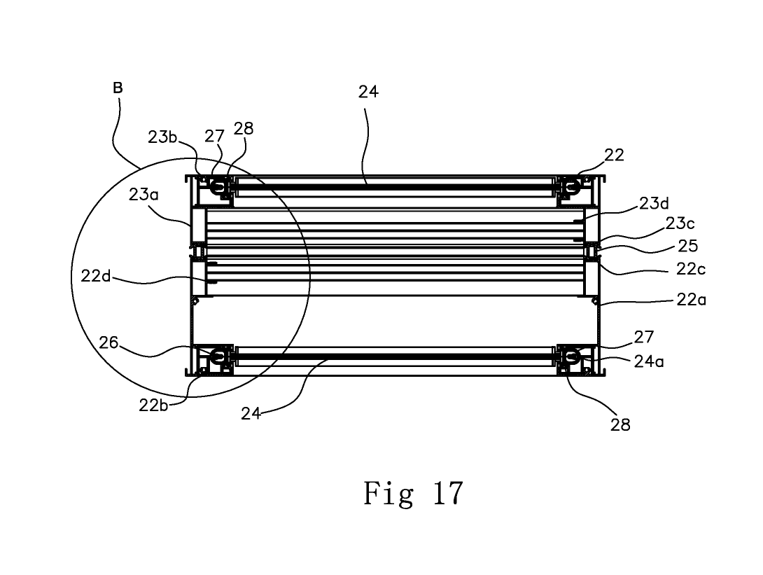

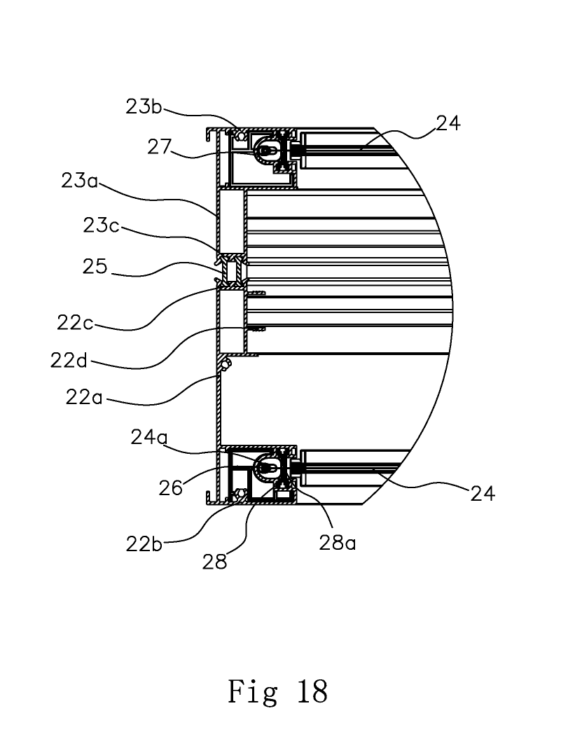

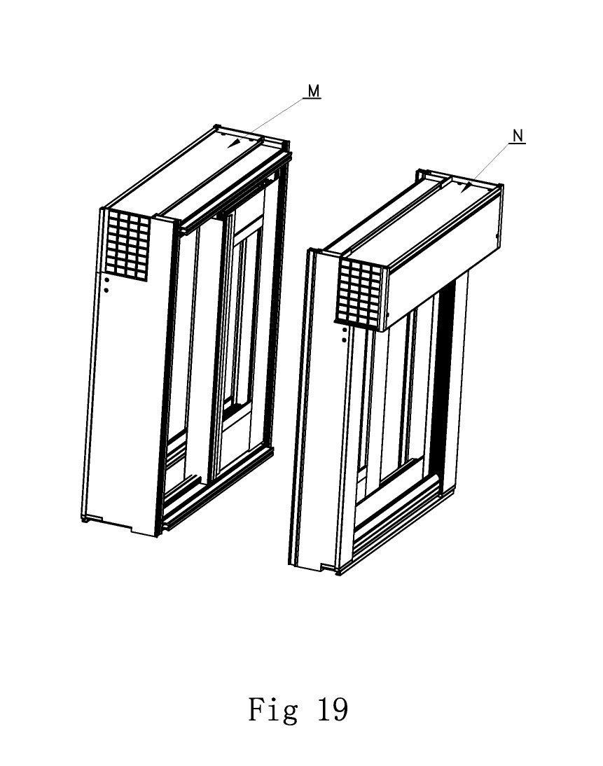

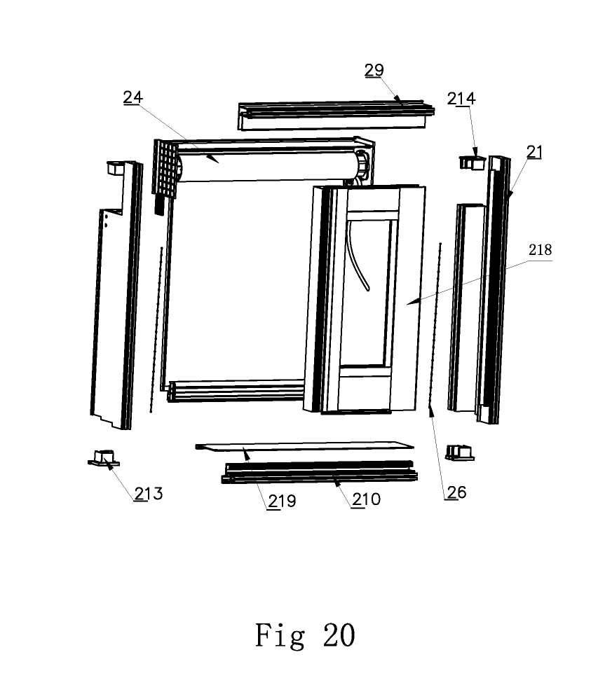

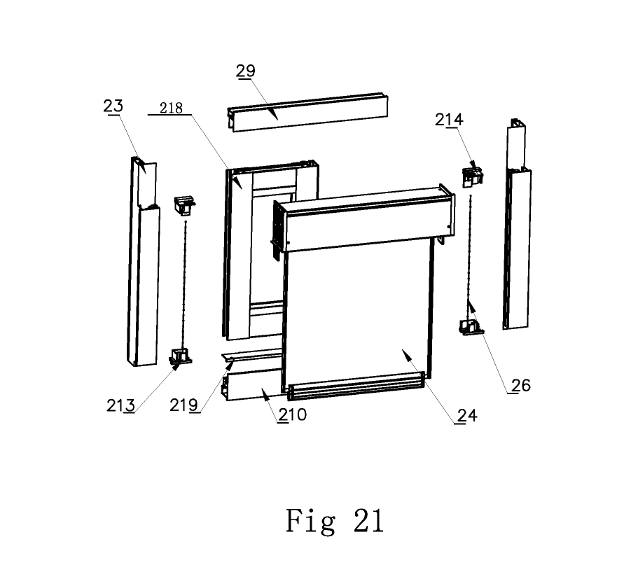

Two front and back window frames are provided in this embodiment. As shown in FIGS. 6-21. the structure and principle of two window frames are the same as each other.

Symmetric front frame bodies 22 are provided on both sides of the front window frame. The front frame body 22 has a front support part 22a and a front guide part 22b. The front frame body is of an elongated L shape. That is to say, a vertical connecting portion is provided between the front support part 22a and the front guide part 22b and a gap 22e is provided on the upper portion of the front support part 22a and the front guide part 22b in which the upper end of the front support part is higher than that of the front guide part. In this embodiment, the front support part 22a is integrated with the front guide part 22b.

A front window cover 21 is mounted outside of the upper portion of the front frame body 22. The width of the front gap 22e formed between the front guide part 22h and the front support part 22a is identical to that of the window cover. The front window cover 21 is fixedly mounted at the front gap 22e in the process of mounting, which ensures the front window cover 21 not to be exposed and projected out of the window all alone. As such, the front half of the window, i.e., the portion exposed out of the outer wall, is a square frame, producing art overall aesthetic appearance of the window.

An upper slide 29 is mounted between the upper ends of the two support parts on both sides of the front frame body and a lower slide 210 is mounted between the lower ends. A first rail is disposed on the upper slide and a second rail is disposed on the lower slide corresponding to the first rail. The rails on the upper slide 29 and lower slide 210 could facilitate horizontal movement of the sliding window. The bottom surface of the lower slide 210 is covered by the window frame seal plate 224.

Symmetric back frame bodies 23 are provided on both sides of the back window frame, The back frame body 23 has a back support part 23a and a back guide part 23b. The back frame body is of an elongated L shape. That is to say, a vertical connecting portion is provided between the back support part 22a and the back guide part 23b and a gap 23e is provided on the upper portion of the back support part 23a and the back guide part 23b in which the upper end of the back support part is higher than that of the back guide part. In this embodiment, the back support 23a is integrated with the back guide part 23b.

A back window cover 217 is mounted outside of the upper portion of the back frame body 23. The width of the back gap 23e formed between the back guide part 23b and the back support part 23a is smaller than that of the back window cover 217. As the back frame body 23 faces to inside of the room, the back frame body 23 could not project out of the wall in view of aesthetic. appearance and harmony of the whole product. The back window cover 217 could not have an excessively small area as a tubular motor 211 is mounted within the back window cover. Therefore, the width of the back gap 23e formed between the back guide part 23b and the back support part 23a of the back frame body 23 is smaller than that of the back window cover 217, so that the back window cover 217 could project out of the wall all alone.

An upper slide 29 is mounted between the upper ends of the two support parts on both sides of the back frame body and a lower slide 210 is mounted between the lower ends. A first rail is disposed on the upper slide and as second rail is disposed on the lower slide corresponding to the first rail. The rails on the upper slide 29 and lower slide 210 could facilitate horizontal movement of the sliding window. The bottom surface of the lower slide 210 is covered by the window frame seal plate 223.

In this embodiment, both the front window cover 21 and the back window cover 217 are fixed to the upper part of the front frame body 22 and that of the back frame body 23 by bolts respectively.

The front support 22a is fixedly connected to the back support part 23a via a plastic strip 25. In particular, a first slot 22c is opened on one side of the front support part 22a and a second slot 23c is opened on one side of the back support 23a corresponding to the first slot 22c. Two long sides of the plastic strip 25 are inserted and fixed into the first slot 22c and the second slot 23c respectively. The plastic strip 25 is of an I-shape section. In the process of mounting, the front frame body 22 is firstly aligned with the back frame body 23, and the plastic strip 25 is aligned with and inserted and fixed into the first slot 22c and the second slot 23c, and then fixed into the first slot 22c and the second slot 23c via two long sides of the plastic strip 25 respectively, so that the front frame body 22 is connected with the back frame body 23 which incurs convenient mounting. The window frame is made from aluminum alloys as a whole, in which both the front support part 22a of the front frame body 22 and the back support part 23a of the back frame body 23 are hollow plates which are transversely circumferentially closed and have openings at two longitudinal ends. Consequently, the production cost is reduced and a good heat insulating effect is provided while the firmness of the window is guaranteed.

After the front and back window frames are connected with each other via the plastic strip, the corresponding upper and lower slides thereof are fixed to each other as well. The two upper slides are connected with each other via a plastic strip (heat insulating strip), and the two lower slides are connected with each other via the other plastic strip (heat insulating strip).

A front frame body limiting part 22d is disposed on the inner side of one front support 22a for positioning the sliding window, and a back frame body limiting part 23d is disposed on the inner side of the opposite back support part 23a for positioning the other sliding window. The sliding windows could be conveniently mounted and positioned through the said two limiting parts.

A blind cloth roll mechanism is set within each of the front window over 21 and the back window cover 217. In this embodiment, the blind cloth roll mechanisms both include a tubular motor 211 mounted at the reel pipe 216. The upper edges of the two blind cloths 24 are fixed to the walls of corresponding reel pipes 216 respectively. The blind cloth 25 is wound outside of the reel pipe 216. The reel pipe 26 can he driven to rotate to automatically lift the blind cloth 24 up and down by activating the tubular motor 21, thereby rolling the blind cloth 24 in and out.

An active wheel plug 225 and a passive wheel plug 226 are respectively inserted and fixed into both ends of the reel pipe 216. The width of the curtain cloth 24 is larger than the length of the reel pipe 216. The portions of the active wheel plug 225 and passive wheel plug 226 exposed out of the reel pipe 216 are provided with an annular groove 226A and the outer diameter of the annular groove is smaller than the diameter of the reel pipe 216. When the curtain cloth 24 is wound around the reel pipe 216, both lateral skirts of the curtain cloth 4 are wound at the corresponding annular grooves respectively. Therefore, the outer diameter of the skirt after being wound could be effectively reduced, and the curtain cloth will he prevented being displaced. The length of the annular groove is 15-40 mm and the depth thereof is 2-6 mm.

A bead chain 26 having a length equal to the skirt is disposed within each of both lateral skirts 24a of the blind cloth 24 in the longitudinal direction. Both ends of the bead chain 26 are fixed to the skirt. The bead chain is made from several plastic beads fixed on a nylon rope and prearranged in an equal distance. The distance between adjacent beads is 12-20 mm and the diameter of the beads is 2.5-4 mm. When the curtain cloth 24 is lifted up and wound by the reel pipe 216, the bead chain 26 within the skirt is wound and located at the corresponding annular groove, as the curtain cloth 24 is lifted up. In this embodiment, when the blind cloth is wound around the reel pipe, the beads of the bead chain within two adjacent blind cloth skirts will not over hip with each other. which ensures the curtain cloth not be displaced while being wound around the reel pipe.

An end cap 212 is mounted at each of both ends of the front and back window covers. The end cap 212 is in rotary cooperation with the reel pipe 216. An extension 212b is provided on the end cap 212. The end cap 212 could be fixed to the support part o the window frame by inserting and fixing the extension 212b into the window frame support part, thereby guaranteeing firmness of the blind. The blind cloth 24 mounted on the front window cover 21, i.e., located at the outer wall portion, is made from sun-proof materials, and the blind, cloth 24 mounted on the back window cover 217, i.e., located at the indoor portion, is made from screen window cloth. Two pieces of blind cloth 24 could be put down according to actual circumstances, and could prevent sunshine, mosquito and wind entering into the room. A heat dissipation hole is opened on the end cap 212.

A rail 27 is disposed within each of the front guide part 22b of the front frame body 22 and the back guide part 23b of the back frame body 23. The rail 27 is integrated with a corresponding guide part to facilitate production. A longitudinal opening is provided on one side of the guide part 22b facing to the blind cloth 24. The rail 27 is provided with an opening slot in the longitudinal direction. The opening of the opening slot faces to one side of the blind cloth 24, and the upper mouth of the opening slot is in communication with the window cover 21. Two symmetrically disposed scaling plugs 28 are mounted within each of the ports of the front guide part 22b and back guide part 23b close to the rail 27. An aperture 28a is formed between two sealing plugs 28. Both lateral edges of the blind cloth 24 extend into the opening slot after passing through the longitudinal opening of the guide part 22b on the same side and the opening of the opening slot.

The diameter of the beads o the bead chain 26 is larger than the caliber of the aperture 28a. When the bead chain within the skirt is wound along with the blind cloth, the distance among the beads could make the beads on the bead chain scattered and stacked, thereby effectively reducing the outer diameter of the skirt after being wound, and preventing the blind cloth from being displaced. The skirt 24a passes through the aperture 28a between two sealing plugs 28 and could move up and down. The skirt 24a is made from ordinary nylon composite materials or ordinary chemical fiber materials, has a good tensile strength and is not easy to be broken. The skirt 24a could be folded lengthwise to form a circumferentially closed space. When the skirt 24a is rolled in along with the blind cloth 24, the skirt 24a is flattened, the thickness of the skirt 24a is identical to that of the blind cloth 24, and the skirt 24a is always kept flat to prevent the blind cloth 24 from being displaced. When the wind blows to the blind cloth 24, the blind cloth 24 is pulled by two bead chains 26 through the skirt 24a, so that the blind cloth 24 is pulled straight and the bead chains 26 are always restricted within the rail 27 and not disengaged from the rail in the meantime. The blind cloth 24 and skirt 24a could be fixed to each other by hot sealing under temperature of 150-400° C. by using a hot sealing machine or by sewing by using a sewing machine.

A bottom plug 213 is mounted at the lower end of the window frame guide part and a guide plug 214 is mounted at the upper end of the guide part. The impurities including dust will not enter into the window frame guide part by using the bottom plug 213 and the guide plug 214, which guarantees tidiness of the rail 27 within the window frame guide part, prevents too many impurities from blocking the rail 27, and reduces difficulty of the blind cloth 24 to lift up and down.

A wire wheel holder 230 and a roller 227 are vertically disposed upward from the bottom plug 213. A steel wire wheel 231 having a scroll spring 228 is mounted on the wire wheel holder 230. A traction steel wire 229 is wound around the steel wire wheel 231. One end of the traction steel wire 229 is wound around the steel wire wheel 231, and the other end passes through the roller 227 and is fixedly connected with the lower rod 220. An annular groove is opened on the roller 227. The traction steel wire 229 passes through the annular groove. The annular groove has guiding and positioning functions to make sure the traction steel wire 229 will not be displaced when passing the roller 227. When the curtain cloth 24 is lifted up and rolled in by the reel pipe 230, the steel wire wheel 213 turns to release the traction steel wire 229 and the traction steel wire 229 tightens the scroll spring 228. When the curtain cloth 24 is pulled down, an upward force is exerted on the curtain cloth 24 by wind with impact of the wind pressure, i.e., an upward force is exerted on the lower rod 220. At that time, the lower rod 220 tightens the traction steel wire 229 and tends to move up, while the steel wire wheel 231 is to furl the traction steel wire 229. Therefore, both ends of the traction steel wire 229 are tightly pulled. As the scroll spring 228 is in a tense state previously, the scroll spring 228 releases its elastic force and drives the curtain cloth to move down (i.e., to exert a downward force on the lower rod 220) when the curtain cloth 24 drops. The elastic force released by the scroll spring 228 could offset and eliminate the force exerted on the lower rod 220 by the wind force, thereby ensuring the curtain cloth 24 to move down smoothly even when it is subject to wind pressure. Meanwhile, one end of the traction steel wire 229 is fixed on the steel wire wheel 231 and the other end thereof only passes through the roller 227 and is directly fixed on the lower rod, thereby reducing the winding path of the traction steel wire 229, and guaranteeing smoothness of upward and downward movement of the curtain cloth 24 under action of the steel wire wheel 231 and a better traction effect.

A lower rod 220 is connected with the lower edge of the blind cloth. The lower rod 220 is of a hollow shape and both ends thereof are sealed by a lower rod plug 22 respectively. A rubber strip 221 is mounted in a lengthwise direction on the lower surface of the lower rod 220. A reverse convex slot is formed on the lower surface of the lower rod 220 along the lengthwise direction. The rubber strip 221 is inserted and fixed into the slot and partially projects from the lower surface of the lower rod 220.

The specific embodiments described herein are merely illustrative of the spirit of the invention, It is apparent to those skilled in the art that various modifications, amendments and alternatives can be made to these embodiments without departing from the spirit or scope defined by the appended claims.

### REFERENCE NUMERALS

FIGS. 1-5

11 Curtain Cloth

11a Skirt

12 Window Cover

13 Reel Pipe

14 Lateral Rail

15 Lower Rod

16 Rocker Rod

17 Positioning Element

18 Active Wheel Plug

19 Passive Wheel Plug

110 Annular Groove

111 Bulkhead

112 Guide Blank Cap

113 End Cap

114 Lock Bar

115 Gap

116 Wire Wheel Holder

117 Steel Wire Wheel

118 Scroll Spring

119 Fraction Steel Wire

120 Roller

121 Rocker Gear Case

122 Hang Ring

FIGS. 6-21

21 Front Window Cover

22 Front Frame Body

22a Front Support Part

22b Front Guide Part

22c First Slot

22d Front Frame Body Limiting Part

22e Front Gap

23 Back Frame Body

23a Back Support Part

23b Back Guide Part

23c Second Slot

23e Back Frame Body Limiting Part

24 Back Gap

24a Blind Cloth

24a Skirt

25 Plastic Strip

26 Bead Chain

27 Rail

28 Sealing Plug

28a Aperture.

29 Upper Slide

210 Lower Slide

211 Tubular Motor

212 End Cap

212b Extension

213 Bottom Plug

214 Guide Plug

215 Positioning Piece

215a Elliptic Groove

216 Reel Pipe

217 Back Window Cover

218 Sliding Window

219 Window Frame Seal Plate

220 Lower Rod

221 Rubber Strip

222 Lower Rod Plug

223 Inner Window Frame Seal Plate

224 Outer Window Frame Seal Plate

225 Active Wheel Plug

226 Passive Wheel Plug

1. A wind-resistant sun-proof blind, comprising a curtain cloth, a window cover and a reel pipe assembly rotably mounted within the window cover, in which the curtain cloth is wound outside of the reel pipe assembly, the reel pipe assembly tans to drive the curtain cloth to roll out or in, each of both ends of the window cover has a downward lateral rail fixedly connected therewith, the side of the lateral rail facing to the curtain cloth has a longitudinal opening, characterized in that, two symmetrically disposed lock bars are mounted within the lateral rail along the longitudinal direction, and a gap facing to one side of the curtain cloth is formed between the said two lock bars, and the upper opening of the gap is in communication with the window cover; two lateral edges of the curtain cloth extend into the inner cavity of the lateral rail and are transversely fixedly connected with a flexible positioning element after passing through the longitudinal opening of the lateral rail on the same side and the gap between the said two lock bars respectively, the reel pipe assembly has two symmetrically disposed annular grooves and when the curtain cloth is wound around the reel pipe, both lateral edges of the curtain cloth are wound at the corresponding annular grooves respectively, and the outer diameter of the positioning element is larger than the width of the gap between the two lock, bars.

2. The wind-resistant sun-proof blind as claimed in claim 1, characterized in that, the reel pipe assembly includes a reel pipe and an active wheel plug and a passive wheel plug inserted and fixed into both ends of the reel pipe, the annular grooves are opened on the portions of the active wheel plug and passive wheel plug exposed out of the reel pipe respectively, and the outer diameter of the annular grooves is smaller than the diameter of the reel pipe and the width of the curtain cloth is larger than the length of the reel pipe.

3. The wind-resistant sun-proof blind as claimed in claim 1, characterized in that, the length of the positioning element is identical to that of the curtain cloth and the positioning element is fixedly connected with the lateral edge of the curtain cloth by sewing.

4. The wind-resistant sun-proof blind as claimed in claim 3, characterized in that, each of both lateral edges of the curtain cloth is fixedly connected with a skirt, and the curtain cloth is transversely fixedly connected with the positioning element through the skirts.

5. The wind-resistant sun-proof blind as claimed in claim 1, characterized in that, the lower edge of the curtain cloth is connected with a transversely disposed lower rod, the lower end of the lateral rail is fixedly connected with a bulkhead, a steel wire wheel having a scroll spring, is mounted on the bulkhead, a traction steel wire is wound around the steel wire wheel and has one end wound and fixed onto the steel wire wheel and the other end fixedly connected with the lower rod.

6. The wind-resistant sun-proof blind as claimed in claim 1, characterized in that, a rocker gear case having a hang ring is connected with the outer end of the active wheel plug and a vertically disposed rocker is hung onto the hang ring.

7. The wind-resistant sun-proof blind as claimed in claim 1, characterized in that, the positioning, element is a soft traction steel wire or a nylon rope.

8. The wind-resistant sun-proof blind as claimed in claim 1, characterized in that, the positioning element is a bead chain.

9. The wind-resistant sun-proof blind as claimed in claim 8, characterized in that, two said window covers are provided including a first window cover and a second window cover; two said curtain cloths are provided including a first telescopic curtain cloth and a second telescopic curtain cloth; the first window cover is mounted at the upper portion of the first window frame, the first window frame has a first window and the first telescopic curtain cloth is provided within the first window cover;
the second window frame is fixedly connected with one side of the first window frame: and has a second window, the second window is corresponding to the position of the first window, the second window cover is mounted at the upper portion of the second window frame, and the second telescopic curtain cloth is provided within the second window cover; or, a lateral seal is fixedly connected with one side of the first window frame and has a second window, and the second window is corresponding to the position of the first window.

10. The wind-resistant sun-proof blind as claimed in claim 9, characterized in that, symmetric support parts and guide parts are disposed on both sides of the first window frame, the support part and the guide part on the same side are integrated with each other, the upper end of the support part is higher than that of the guide part, that is to Say ,a gap is formed above the support part and guide part on the same side; and the first window cover is mounted at the gaps on both sides of the first window frame.

11. The wind-resistant sun-proof blind as claimed in claim 10, characterized in that, an upper slide is connected with the upper end of the support parts on both sides, a lower slide is connected with the lower end of the support parts on both sides, and the upper slide is corresponding to the lower slide.

12. The wind-resistant sun-proof blind as claimed in claim 10, characterized in that, the lateral seal is formed by vertical seals on both sides, the upper slide connected with the upper end of the seals on both sides and the lower slide connected with the lower end of the seals on both sides, in which the upper slide is corresponding to the lower slide.

13. The wind-resistant sun-proof blind as claimed in claim 12, characterized in that, a first slot is opened on one side of the support part along the longitudinal direction, and a second slot is opened on one side of the lateral seal along the longitudinal direction correspondingly; and two lateral edges of a plastic strip are inserted and fixed into the first slot and the second slot on the same side respectively.

14. The wind-resistant sun-proof blind as claimed in claim 12, characterized in that, a lateral seal limiting part is provided on the inner side of the seal on one side for positioning the sliding window, and a window body limiting part is provided on the inner side of the first window frame support part on the opposite side.

15. The wind-resistant sun-proof blind as claimed in claim 11, characterized in that, symmetric support parts and guide parts are disposed on both sides of the second window frame, the support part and the guide part on the same side are integrated with each other, the upper end of the support part is higher than that of the guide part, that is to say, a gap is formed above the support part and guide part on the same side; and the second window cover is mounted at the gaps on both sides of the second window frame.

16. The wind-resistant sun-proof blind as claimed in claim 8, characterized in that, the bead chain is made from several plastic beads fixedly connected to one nylon rope and spaced from each other, the distance between adjacent beads is 12-20 mm, and the diameter of the beads is 2.5-4 mm.

17. The wind-resistant sun-proof blind as claimed in claim 1, characterized in that, the length of the annular grooves is 15-40 mm and the depth thereof is 2-6 mm.
